(19) United States
(12) Patent Application Publication
(10) Pub. No.: US 2007/0297049 A1
(43) Pub. Date: Dec. 27, 2007

(54) Illumination Device for Microscopes

(75) Inventors: Harald Schadwinkel, Hannover (DE); Andreas Nolte, Rosdorf (DE); Klaus Becker, Breitenworbis (DE); Thomas Mueller-Wirts, Hannover (DE)

Correspondence Address: REED SMITH, LLP;ATTN: PATENT RECORDS DEPARTMENT, 599 LEXINGTON AVENUE, 29TH FLOOR, NEW YORK, NY, 10022-7650, US

(73) Assignee: Carl Zeiss Microlmaging GmbH

(21) Appl. No.: 11/665,590

(22) PCT Filed: Sep. 28, 2005
(86) PCT No.: PCT/EP05/10471

§ 371 Date: Apr. 17, 2007

(30) Foreign Application Priority Data
Oct. 20, 2004 (DE) 10 2004 051 548.4

(51) Int. Cl. G02B 21/06

(52) U.S. Cl. 359/385

(57) ABSTRACT

An illumination device for microscopes is detachably connected to the microscope and has at least one unconventional illumination source such as an LED, laser or the like. The microscope has an operating control for adjusting the brightness of the illumination, and the brightness of the unconventional illumination source is adjusted by means of this operating control.

### CROSS-REFERENCE TO RELATED APPLICATIONS

This application claims priority of International Application No. PCT/EP2005/010471, filed Sep. 28, 2005 and German Application No. 10 2004 051 548.4, filed Oct. 20, 2004, the complete disclosures of which are hereby incorporated by reference.

### BACKGROUND OF THE INVENTION

a) Field of the Invention

The invention is directed to an illumination device for microscopes which relies on the use of unconventional illumination sources. By unconventional illumination sources is meant hereinafter LEDs (light emitting diodes), lasers, OLEDs (organic light emitting diodes) or other illumination sources not relying on the incandescent effect of hot materials. For reasons of simplicity, the examples will be explained with reference to LEDs, but are also applicable to other illumination sources.

b) Description of the Related Art

Conventional microscopes have conventional light sources such as halogen lamps or the like for illuminating specimens. The brightness of these light sources must be controlled to adapt to the respective specimen, and the microscopes have corresponding operating controls for this purpose. Since these lights are often connected externally, they have electric plug-in connectors by which they can be connected to a socket of the microscope. The corresponding operating control at the microscope controls the voltage applied to the socket and, therefore, the brightness of the light source.

DE 37 34 691 proposes the use of LEDs as a light source for microscopes. As the parameters of LEDs improved over the course of their development (higher light yields, white light LEDs, and so on), their use in microscopy became more attractive. Examples for this use include DE 199 19 096, DE 100 17 823, DE 102 14 703 and DE-GM 298 16 055.

In this connection, it has proven disadvantageous that these LED illuminators must be provided with their own specific control circuits for regulating brightness because of the electrical properties of LEDs. These control circuits are usually accommodated in their own control device so that the regulation of brightness is carried out with an operating control of the control device and is therefore complicated and bothersome for the user of the microscope.

It is the object of the invention to overcome the disadvantages of the prior art and, in particular, to provide an acceptable solution for the user to retrofit existing microscopes with LED illuminators.

This object is met through the features of the independent claims. Advantageous constructions are indicated in the dependent claims.

It is particularly advantageous when the illumination device according to the invention can be connected to the voltage supply of the external halogen lamp and the operating control provided for regulating this lamp at the microscope can be used for regulating the brightness of the LED illuminator.

A particularly simple solution consists in connecting an appropriately dimensioned resistance network of the LED or LEDs which converts the voltage range used to regulate the brightness of the halogen lamp to that for a corresponding change in the brightness of the LEDs.

An especially preferred embodiment form of the invention is characterized by the use of pulse width modulation to prevent the shifts in the radiated wavelength and therefore in the color of the light which are produced due to design when the brightness of the LEDs is regulated by changing the applied voltage. For this purpose, a constant voltage is applied in a pulsed manner to the LEDs at a frequency far above the temporal resolution limit of the human eye (max. 50 Hz) and the brightness is adjusted by changing the time ratio between applied voltage (LED bright) and zero voltage (LED dark).

The circuit needed for actuating the pulse width modulation is obtained from the applied voltage that is adjusted by the user based on the user's selected brightness regulation. This means that the voltage corresponding to the desired brightness simultaneously supplies the control circuit and the LEDs and, further, is evaluated for purposes of controlling the pulse width circuit for adjusting the corresponding brightness.

The special advantage of the invention consists in that no additional control unit is needed when retrofitting a microscope with a modem LED illumination or laser illumination. Further, the user can use the corresponding operating control arranged on the microscope stand for controlling brightness.

The invention will be described more fully in the following with reference to the drawings.

### BRIEF DESCRIPTION OF THE DRAWINGS

In the drawings:

FIG. 1 is a schematic illustration of the beam path in a microscope;

FIG. 2 shows a first embodiment example with series resistors;

FIG. 3 shows a second embodiment example with a variable current source;

FIG. 4 shows a third embodiment example with a pulse width circuit; and

FIG. 5 shows a graph with different voltage/brightness characteristic curves.

### DESCRIPTION OF THE PREFERRED EMBODIMENTS

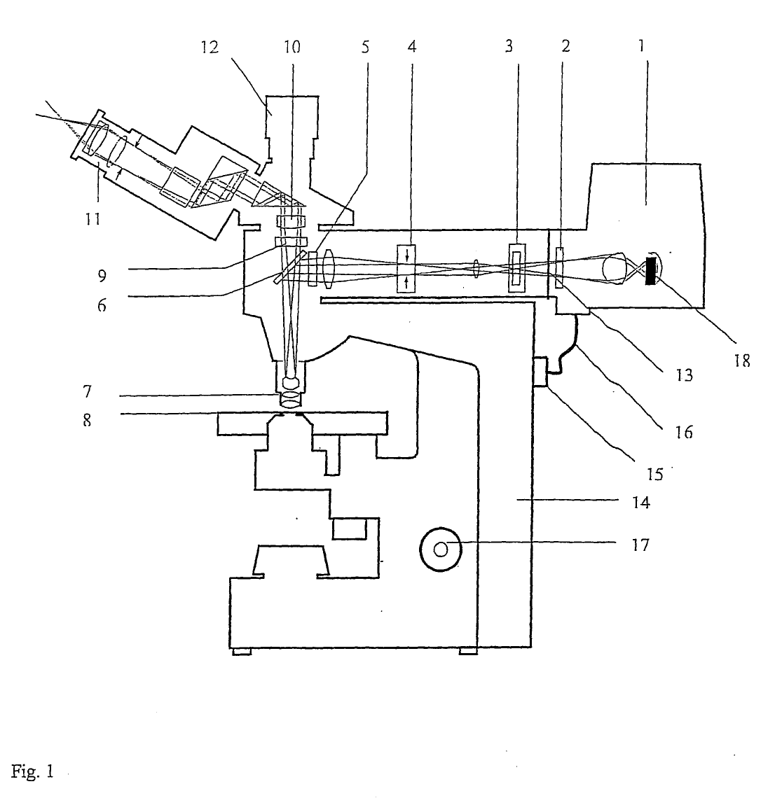

FIG. 1 is a schematic drawing showing the entire beam path in a microscope. The light is directed from a light source 1 via a protective filter 2, aperture diaphragm 3, and field diaphragm 4 to the excitation filter 5. The splitter mirror 6 reflects the excitation light onto the object 8 via the objective 6. The fluorescent light generated by the excitation light in the object 8 in turn passes the objective 7 and is then passed by the splitter mirror 6 and is imaged through the emission filter 9 on the tube lens 10 and from the latter into the eyepiece 11 via a prism system. Alternatively the light can also be imaged by means of a camera arranged at the phototube 12. The light source 1 is detachably connected to the microscope stand 14 by a mechanical interface 13. The voltage is supplied to the light source 1 via an electrical interface 15 (e.g., a socket) arranged at the microscope stand 14 and a line 16. The variable voltage applied to the interface 15 is regulated by an operating control 17 by the user corresponding to the user's brightness requirements. But it is also possible to provide buttons for defined brightness values or color temperature values. The actual illumination source 18 is, for example, an LED array which comprises a regular two-dimensional arrangement of white light LEDs, although other possibilities such as individual LEDs or LEDs of different colors are also conceivable. The drawing relates to a fluorescent microscope, but, of course, the invention is also applicable to a conventional microscope.

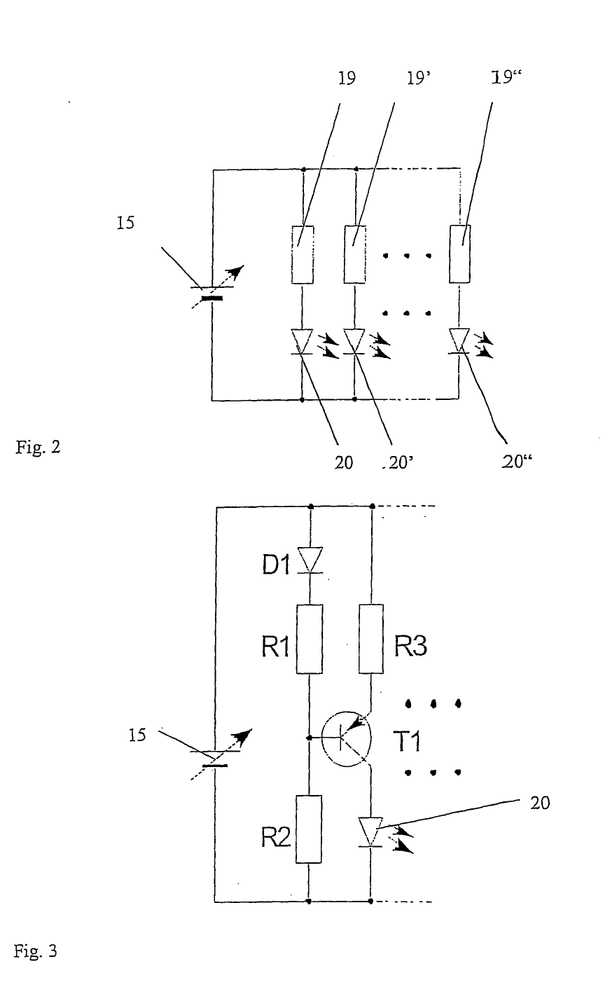

FIG. 2 shows a simple circuit for implementing the invention. The conversion of the variable input voltage at the interface 15 into a variable current is carried out through the use of resistors 19, 19′, 19″. When using LED arrays, the use of a resistor 19, 19′, 19″ for each LED 20, 20′, 20″ is advantageous for compensating differences in the diode characteristic curves. The dimensioning of the resistors R is given by
R=(Umax−ULEDmax)/Imax,
where Umax is the maximum supply voltage at the interface 15, Imax is the maximum current allowed for the LED, and ULEDmax is the voltage drop across the LED at maximum current.

However, a simple conversion of the kind mentioned above of the variable supply voltage to a variable current involves relatively large output losses because the voltage drop across the resistors must be very large in relation to the spread of the current-voltage characteristic curves. It is more favorable instead to use a controlled current source which derives the reference current from the differential supply potential.

A circuit of the type described above is shown in FIG. 3. In this case, only the circuit for one LED is shown. In case of LED arrays, a circuit of this kind is associated with every LED. By means of the resistors R1 and 2 and the diode D1, the reference variable of the current source is generated from the variable supply voltage by transistor T1 and measurement resistor R3, so that a current that is approximately proportional to the supply voltage flows through the LED 20.

One disadvantage of the simple variants described above is that the supply voltage must always be greater than the threshold voltage of the semiconductor sources that are used. It is precisely in LED arrays that series-connected LED elements are often used so as not to cause excessively high total currents and in order to compensate for different characteristic curves. In this case, however, the threshold voltages are added together. In a series connection of three white LEDs, for example, there is a threshold voltage of about 8 . . . 9 Volts. Accordingly, it is no longer possible to adapt the brightness regulation to the halogen lamp because the light flow is already initiated at about 3 V.

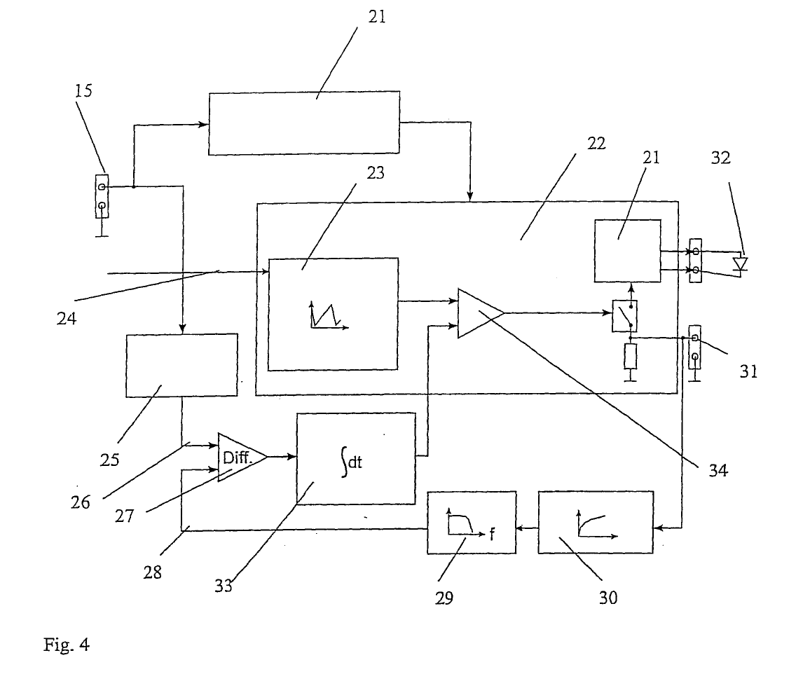

Therefore, a particularly preferred embodiment example is described in FIG. 4. A voltage of e.g. 12 V for supplying the pulse width regulator 22 is obtained from the variable voltage applied to the interface 15 by a step-up converter 21. This pulse width regulator 22 has a ramp generator 23 which can optionally be controlled by an external trigger 24. A reference value 26 is formed as an input for a differential amplifier 27 from the voltage which is applied to the interface 15 and which represents the reference brightness by means of the circuit 25 (for example, by a Zener diode, which converts the reference voltage only after about 3 V, and by a voltage divider by which a calibrating factor can be adjusted). The differential amplifier 27 compares this reference value 26 with an actual value 28 that is obtained via a low-pass 29 and an adaptation circuit 30 from the actual current value 31 for controlling the LED array 32. The differential signal of the differential amplifier 27 is given to an integral regulator 33 that is connected to a comparator 34. The second input of the comparator 34 is connected to the output of the ramp generator 23. The latter generates a division between bright and dark phases for the LED array 32 from the correcting variable given by the regulator 33 and from the pulsed voltage curve given by the ramp generator 23, which division corresponds to the desired brightness. The change between these phases is carried out at a frequency higher than that which can be resolved by the human eye or by a camera which may be connected to the camera output 12 and therefore only the integral brightness corresponding to the value adjusted at the operating control 17 is registered. For the human eye it is sufficient when the frequency is appreciably above 50 Hz; for the camera, this frequency depends on the integration time of the camera and is typically in the kHz range or above. The adaptation circuit 30 can be used in connection with the low-pass 29 to generate a desired characteristic curve for the relationship between the voltage applied to the interface 15 and the luminous flux emitted by the LED array 32. For this purpose, it can produce a corresponding nonlinear curve between the input and output.

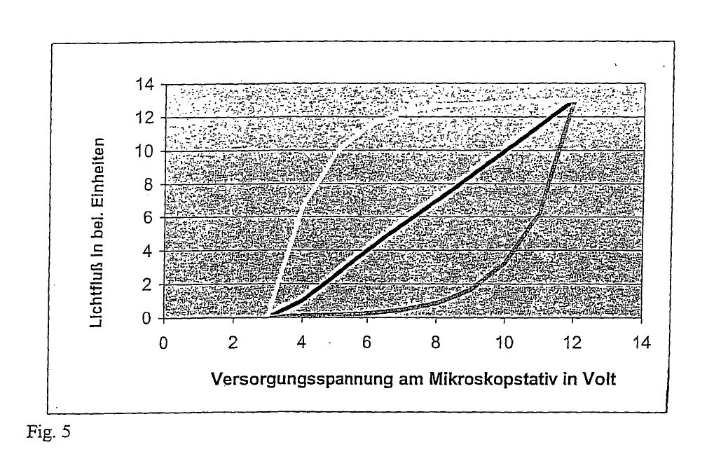

FIG. 5 gives examples of characteristic curves of this kind. Accordingly, the characteristic curve of a halogen lamp can be simulated exactly, but a linear curve or other curve can also be produced specifically.

The invention is not limited to the embodiment examples shown herein. Further developments carried out by the person skilled in the art, e.g., by means of other circuit variants, do not constitute a departure from the protected field.

While the foregoing description and drawings represent the present invention, it will be obvious to those skilled in the art that various changes may be made therein without departing from the true spirit and scope of the present invention.

Claims

1

-

8

(canceled)

9. An illumination device for microscopes comprising:
said device being detachably connected to the microscope;
at least one unconventional illumination source such as an LED, laser or the like;
the microscope having at least one operating control for adjusting the brightness of the illumination; and
the brightness of the at least one unconventional illumination source being adjusted by said at least one operating control.

10. The illumination device for microscopes according to claim 9, wherein the voltage which is applied to an interface of the microscope and which is influenced by the operating control is used for adjusting the brightness of the at least one unconventional illumination source.

11. The illumination device for microscopes according to claim 10, wherein the at least one unconventional illumination source is connected to at least one resistor which causes the voltage applied to the interface to be converted into a voltage that is adapted to the voltage/brightness characteristic curve of the unconventional illumination source.

12. The illumination device for microscopes according to claim I 1, wherein a plurality of unconventional illumination sources with series-connected resistor are connected in parallel to the interface.

13. The illumination device for microscopes according to claim 12, wherein the resistors connected to the respective unconventional illumination sources are so dimensioned that they compensate the individual differences of the voltage/brightness characteristic curve of the respective unconventional illumination sources.

14. The illumination device for microscopes according to claim 10, wherein a controlled current source is connected to the at least one unconventional illumination source and derives a reference current for controlling the unconventional illumination source from the voltage applied to the interface of the microscope.

15. The illumination device for microscopes according to claim 10, wherein the unconventional illumination source is controlled in a pulsed manner and a control circuit with pulse width modulation is connected to the unconventional illumination source, wherein the supply voltage of the control circuit is obtained from the voltage applied to the interface, and wherein a pulse-duty factor of the pulse widths which corresponds to the applied voltage is generated by the control circuit so that the resulting brightness of the unconventional illumination source is controlled by means of the operating control at the microscope.

16. A microscope further comprising an illumination device according to claim 9.
